(19) United States
(12) Patent Application Publication
(10) Pub. No.: US 2021/0306556 A1
(43) Pub. Date: Sep. 30, 2021

(54) IMAGE PROCESSING DEVICE, IMAGE PROCESSING METHOD, AND NON-TRANSITORY RECORDING MEDIUM

(71) Applicant: CASIO COMPUTER CO., LTD., Tokyo (JP)

(72) Inventor: Yoshiyuki KATO, Tokyo (JP)

(21) Appl. No.: 17/211,651

(22) Filed: Mar. 24, 2021

(30) Foreign Application Priority Data
Mar. 25, 2020 (JP) 2020-054105

(51) Int. Cl. H04N 5/232; G06K 9/00; G06T 7/579

(52) U.S. Cl. CPC H04N 5/23218; G06T 7/579; G06K 9/00255; G06K 9/00664

(57) ABSTRACT

An image processing device includes a memory storing a program, and at least one configured to execute the program stored in the memory. The processor acquires a captured image, detects a detection target from the image, sets a detection frame being a range for detecting the detection target within the image, determines whether to shrink the detection frame every time a detection operation for the detection target over the entire image is completed, detects, when the detection frame is newly set, the detection target, based on a newly set detection frame, and sets, when determining to shrink the detection frame, a detection frame smaller than a detection frame at a time of the detection operation.

### CROSS-REFERENCE TO RELATED APPLICATION

This application claims the benefit of Japanese Patent Application No. 2020-054105, filed on Mar. 25, 2020, the entire disclosure of which is incorporated by reference herein.

### FIELD

The present disclosure relates to an image processing device, an image processing method, and a non-transitory recording medium.

### BACKGROUND

In a face detection function used in a digital camera and the like, even a camera having a high-pixel imaging sensor generally uses an image with a low resolution of a degree of a quarter video graphics array (QVGA, 320×240 pixels) or a video graphics array (VGA, 640×480 pixels) to perform face detection, as in Unexamined Japanese Patent Application Publication No. 2019-12426.

Further, even face authentication and the like for identifying an individual use an image with a low resolution of a degree of VGA. Such use of a low-resolution image in detection and authentication can prevent deterioration in processing speed.

### SUMMARY

In order to accomplish the above objective, an image processing device according to the present disclosure includes:

a memory storing a program; and

at least one processor configured to execute a program stored in the memory, wherein

the processor
acquires a captured image,
detects a detection target from the image,
sets a detection frame being a range for detecting the detection target within the image,
determines whether to shrink the detection frame every time a detection operation for the detection target over the entire image is completed,
detects, when the detection frame is newly set, the detection target, based on a newly set detection frame, and
sets, when determining to shrink the detection frame, a detection frame smaller than a detection frame at a time of the detection operation.

### BRIEF DESCRIPTION OF THE DRAWINGS

A more complete understanding of this application can be obtained when the following detailed description is considered in conjunction with the following drawings, in which:

FIG. 1 is a diagram illustrating a face authentication system according to an embodiment of the present disclosure;

FIG. 2A is a side view illustrating a positional relation between an imaging device and an imaging range of the face authentication system according to the embodiment of the present disclosure;

FIG. 2B is one example of an image captured by the imaging device of the face authentication system;

FIG. 3 is a diagram illustrating an outline of an image processing flow in the face authentication system according to the embodiment of the present disclosure;

FIG. 4 is a block diagram of an image processing device according to the embodiment of the present disclosure;

FIG. 5 is a diagram describing a minimum face image according to the embodiment of the present disclosure;

FIG. 6 is a diagram describing a detection frame according to the embodiment of the present disclosure;

FIG. 7 is a diagram describing an exclusion range for face image detection;

FIG. 8 is a flowchart of object detection processing according to the embodiment of the present disclosure;

FIG. 9 is a diagram chronologically describing a situation in which the object detection processing is executed; and

FIG. 10 is a diagram describing a state in which a frequency of executing the object detection processing is set for each area.

### DETAILED DESCRIPTION

An image processing device according to an embodiment of the present disclosure will be hereinafter described in detail with reference to the drawings.

The image processing device according to the embodiment of the present disclosure generates image data for causing a face authentication device of a face authentication system to perform face authentication for use in, for example, security or the like for an office or an event. Note that, the number of persons captured in an image is not particularly limited as long as a face image is prevented from being too small. However, in the following description, the number of persons captured in an image is three, for ease of description.

[Configuration of Face Authentication System]

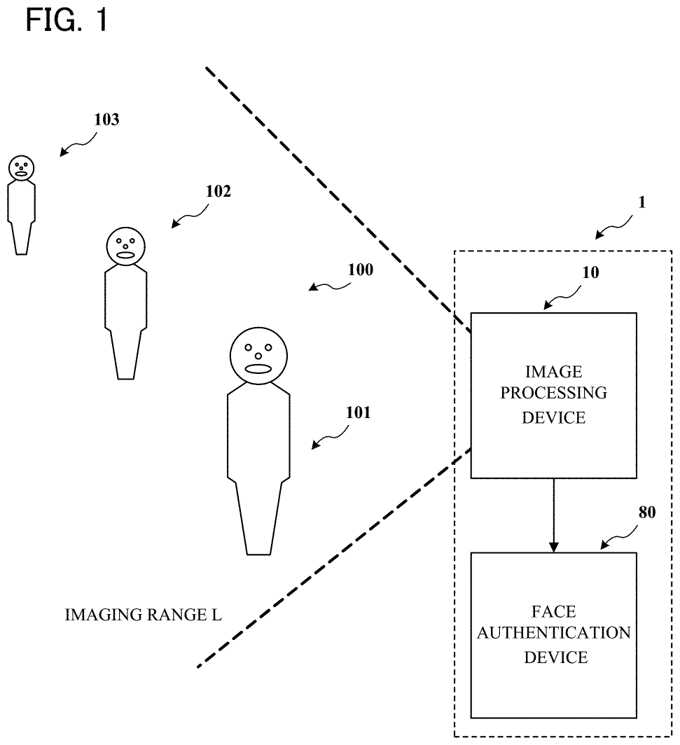

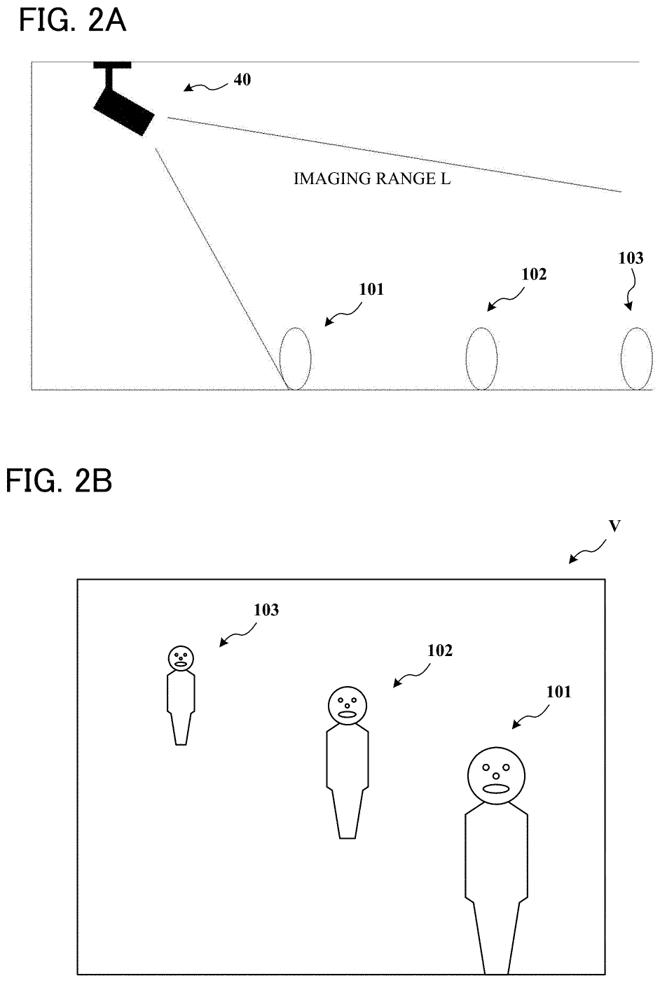

As illustrated in FIG. 1, a face authentication system 1 includes an image processing device 10 and a face authentication device 80. The image processing device 10 captures an image of a person 100 (101, 102, and 103) being an authentication target region existing in an imaging range L of the face authentication system 1, performs object detection processing to be described later, and transmits image data suitable for face authentication to the face authentication device 80. As illustrated in FIG. 2A, persons 101, 102, and 103 move or stand still at different distances from an imager 40 of the image processing device 10. The person 101 is the nearest from the imager 40, the person 102 is the next nearest, and the person 103 is the farthest. Further, the imager 40 is mounted on a ceiling at an entrance of a building, according to the present embodiment. Thus, as illustrated in FIG. 2B, the person 101 is the largest in an image captured by the imager 40, the person 102 is the next largest, and the person 103 is the smallest. Each of face images of the persons 101, 102, and 103 captured at different sizes in an image V is authenticated as a face image stored in a storage 30. Then, in order that the face authentication device 80 can perform face authentication from the near person 101 to the farthest person 103, the image processing device 10 performs the object detection processing and the like to provide image data suitable for face authentication.

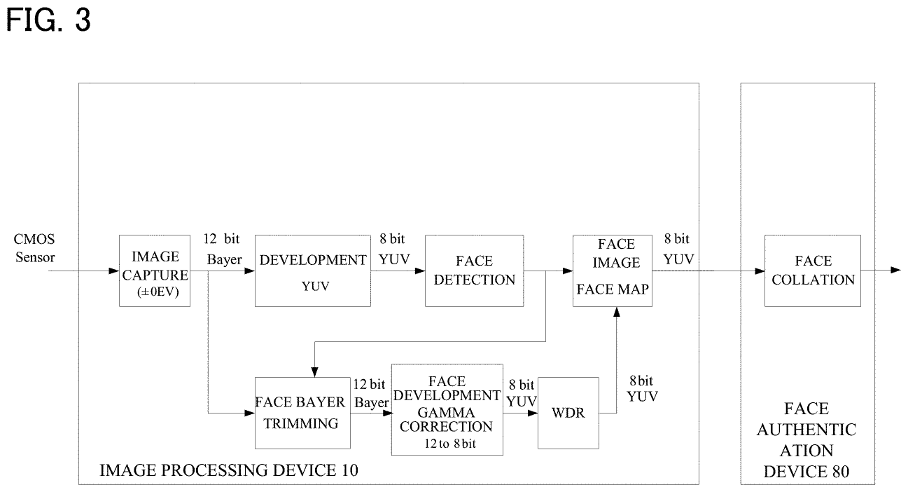

An outline of image processing performed in the face authentication system 1 illustrated in FIG. 3 will be described. An image captured by an imaging device is a 12-bit Bayer image, and the image is developed and gradation-corrected to generate a YUV image compressed into 8 bits. Face detection from the generated image is performed by the image processing device 10, and face collation is performed by the face authentication device 80.

(Configuration of Image Processing Device)

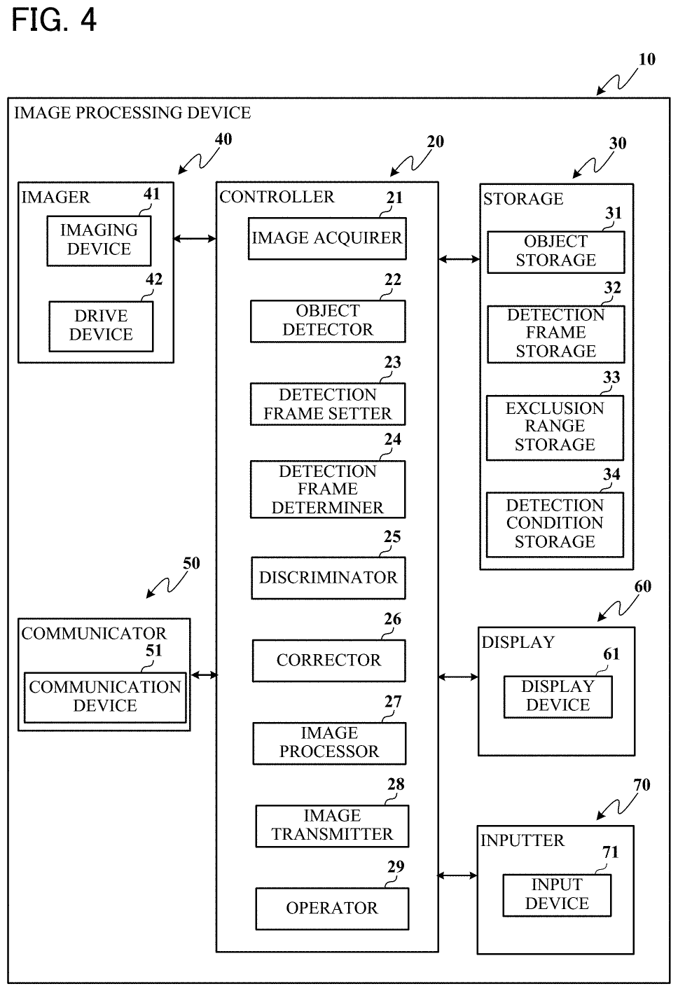

As illustrated in FIG. 4, the image processing device 10 includes a controller 20, the storage 30, the imager 40, a communicator 50, a display 60, and an inputter 70.

The controller 20 includes a central processing unit (CPU) and the like, and achieves a function of each section to be described later (an image acquirer 21, an object detector 22, a detection frame setter 23, a detection frame determiner 24, a discriminator 25, a corrector 26, an image processor 27, an image transmitter 28, and an operator 29) by executing a program and the like stored in the storage 30. Further, the controller 20 includes a clock (not illustrated), and can perform acquiring a current date and time, counting elapsed time, and the like.

The storage 30 includes a read-only memory (ROM), a random access memory (RAM), and the like, and all or part of the ROM includes an electrically rewritable memory (a flash memory and the like). The storage 30 functionally includes an object storage 31, a detection frame storage 32, an exclusion range storage 33, and a detection condition storage 34. The ROM stores a program executed by the CPU of the controller 20 and data necessary in advance for execution of the program. The RAM stores data prepared or changed during execution of the program.

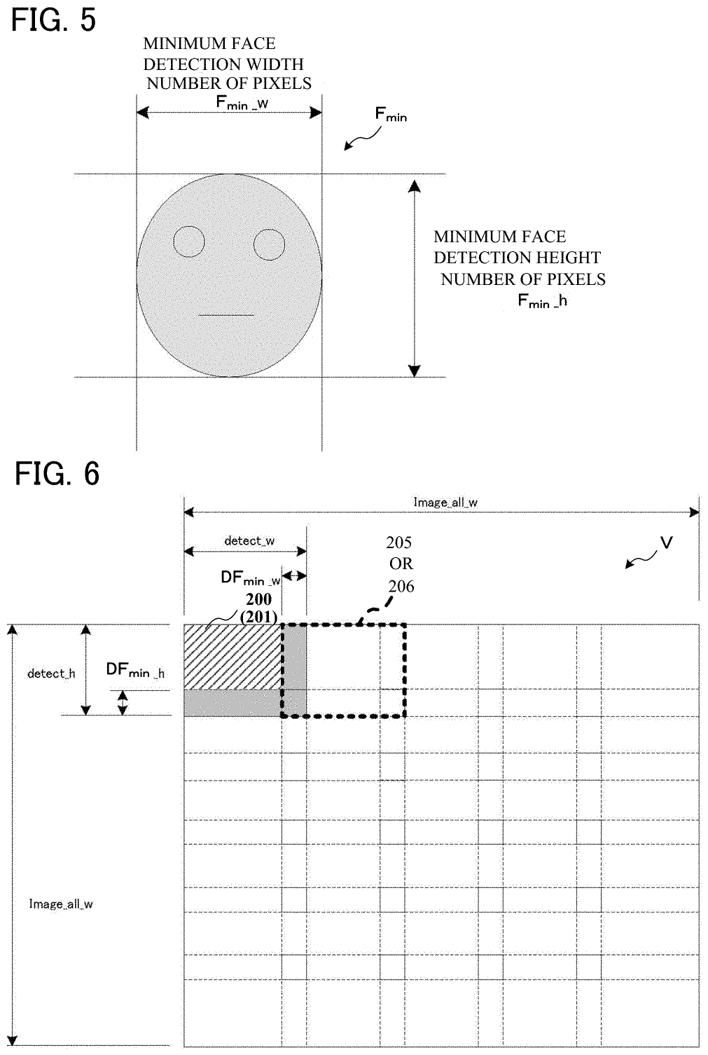

The object storage 31 stores a face image being an object detected from an image captured by the imager 40, according to the present embodiment. Further, the object storage 31 stores a minimum detection face Fₘᵢₙ (see FIG. 5) having a face size detectable in a set detection frame 205 (to be described later). Note that, the minimum detection face Fₘᵢₙ is set to have a face size slightly larger than a detectable face size.

The detection frame storage 32 stores the detection frame 205 set by the detection frame setter 23 and to be described later. Further, the detection frame storage 32 also stores a user-set detection frame 206 voluntarily set by a user. Further, the detection frame storage 32 stores a reference detection frame 200 in advance. Because the image V is divided by the reference detection frame 200, a width and a height of the image V are preferably integer multiples of a width and a height of the reference detection frame 200. The reference detection frame 200 includes a reference detection frame 200₁ for first division, a reference detection frame 200₂ for second division, . . . , and a reference detection frame 200, for n-th division. A width and a height of the reference detection frame 200₁ are equal to a width and a height of the image V. Further, a width and a height of the reference detection frame 200 are the reference detection frame 200₁>the reference detection frame 200₂>. . . >the reference detection frame 200ₙ₋₁>the reference detection frame 200ₙ=the minimum detection face Fₘᵢₙ. Note that, in order to prevent increase in processing load, the reference detection frame 200, can also be set to have any size larger than the minimum detection face Fₘᵢₙ, instead of setting the reference detection frame 200ₙ=the minimum detection face Fₘᵢₙ Further, decreasing a value of n in the reference detection frame 200ₙ can prevent increase in processing load. Note that, the smaller a value of n in the reference detection frame 200ₙ (and a detection frame 205ₙ), the closer to a resolution of an original image.

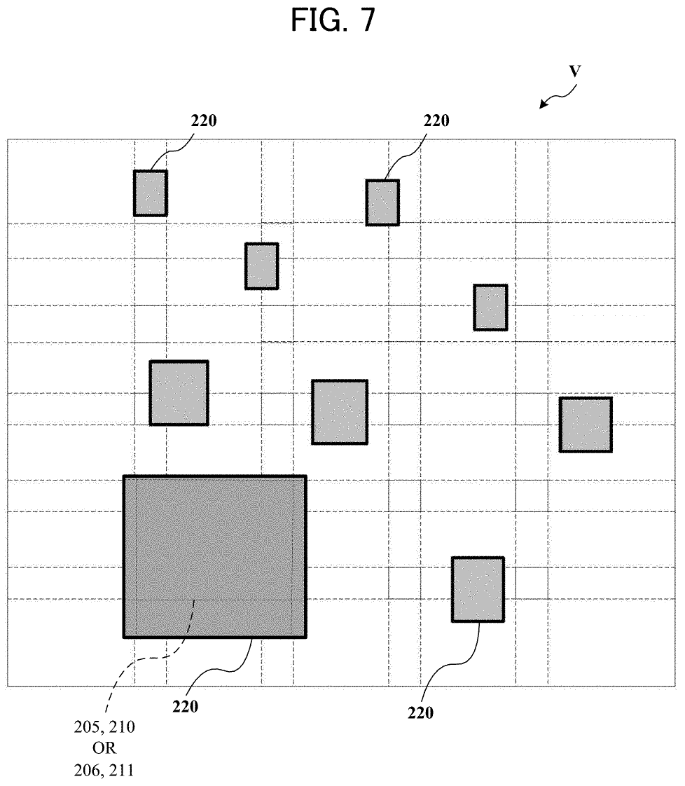

The exclusion range storage 33 stores an exclusion range 210 discriminated and set by the discriminator 25 and to be described later (see FIG. 7). Further, the exclusion range storage 33 also stores a user-set exclusion range 211 voluntarily set by a user. For example, an area (an area where furniture, equipment, and the like are installed, and the like) where no person passes within the imaging range L may be set as the user-set exclusion range 211.

The detection condition storage 34 stores a detection condition Z. The detection condition storage 34 stores, as the detection condition Z, a detection condition Z1 for differentiating a detection frequency for each imaging area, a detection condition Z2 for excluding a range having a predetermined illuminance or more or having a predetermined illuminance or less from a detection target, and the like.

The imager 40 includes an imaging device 41 and a drive device 42.

The imaging device 41 includes a complementary metal oxide semiconductor (CMOS) camera, according to the present embodiment. The imaging device 41 captures the imaging range L at a frame rate of 30 fps to generate the image V. The image V is a Bayer image, and is output with a 12-bit resolution.

The drive device 42 moves, according to an instruction from the operator 29 to be described later, a position of the imaging device 41 to adjust the imaging range L.

The communicator 50 includes a communication device 51 being a module for communicating with the face authentication device 80, external equipment, and the like. The communication device 51 is a wireless module including an antenna when communicating with external equipment. For example, the communication device 51 is a wireless module for performing short-range wireless communication based on Bluetooth (registered trademark). With use of the communicator 50, the image processing device 10 can exchange image data and the like with the face authentication device 80, external equipment, and the like.

The display 60 includes a display device 61 including a liquid-crystal display (LCD) panel.

As the display device 61, a thin-film transistor (TFT) display device, a liquid-crystal display device, an organic EL display device, and the like can be employed. The display device 61 displays the image V, the detection frame 205 to be described later, and the like.

The inputter 70 is a resistive touch panel (an input device 71) provided close to the display 60 or integrally with the display 60. The touch panel may be an infrared ray touch panel, a projected capacitive touch panel, and the like, and the inputter 70 may be a keyboard, a mouse, and the like instead of a touch panel. A user can set the user-set detection frame 206, the user-set exclusion range 211, and the like by using the display 60 through a manual operation via the inputter 70.

Next, a functional configuration of the controller 20 of the image processing device 10 will be described. The controller 20 achieves functions of the image acquirer 21, the object detector 22, the detection frame setter 23, the detection frame determiner 24, the discriminator 25, the corrector 26, the image processor 27, the image transmitter 28, and the operator 29, and performs the object detection processing to be described later and the like.

The image acquirer 21 causes the imager 40 to capture the imaging range L with an exposure condition preset in the image processing device 10 or set by a user, and acquires the image V captured by all pixels in about 33 msec. The image V has a resolution of QVGA. The image acquirer 21 transmits the acquired image V to the object detector 22.

The object detector 22 detects a face image being an object from the image V transmitted from the image acquirer 21, according to the present embodiment. The object detector 22 detects a face image from the image V in about 11 msec by using the detection frame 205 set by the detection frame setter 23 and to be described later. Further, when the user-set detection frame 206 is set, the object detector 22 detects a face image from the image V by using the user-set detection frame 206. The object detector 22 determines whether a face image is detected from the image V by using the detection frame 205. The object detector 22 stores the detected face image in the object storage 31.

The detection frame setter 23 reads a face image in the image V stored in the object storage 31, and sets a width and a height of a smallest face image among the read face images, as a width DF_{min_w} and a height DF_{min_h} of a frame-overlapping area of the reference detection frame 200 illustrated by diagonal hatching in FIG. 6. The detection frame setter 23 adds the width and the height of the frame-overlapping area to a width and a height of the preset reference detection frame 200 to set a width detect_w and a height detect_h of the detection frame 205 (or the user-set detection frame 206) in the detection frame storage 32, and stores the width detect_w and the height detect_h in the detection frame storage 32. After the image processing device 10 acquires the image V, the detection frame setter 23 reads the detection frame 205 from the detection frame storage 32, and divides the image V by the detection frame 205 in such a way as to include the frame-overlapping area.

The detection frame determiner 24 determines whether to shrink the detection frame 205ₙ every time a detection operation for a face image over the entire image V by using the detection frame 205 is completed. The detection frame determiner 24 compares a smallest face among faces detected during the detection operation with the minimum detection face Fₘᵢₙ, and determines to shrink the detection frame 205 when the smallest face is larger. When the detection frame determiner 24 determines to shrink the detection frame 205, the detection frame setter 23 sets a width and a height of the smallest face as a width DF_{min_w} and a height DF_{min_h} of a frame-overlapping area of a reference detection frame 200ₙ₊₁ to set a detection frame 205ₙ₊₁. When the smallest face is equal in size to the minimum detection face Fₘᵢₙ, the detection frame determiner 24 does not determine to shrink the detection frame 205 (the detection frame setter 23 ends an operation of shrinking the detection frame 205).

The discriminator 25, when the detection frame 205 or the user-set detection frame 206 is positioned inside a detected face image 220 already detected by the object detector 22 as illustrated in FIG. 7, discriminates the detection frame 205 or the user-set detection frame 206 as the exclusion range 210 or the user-set exclusion range 211, and stores the exclusion range 210 or the user-set exclusion range 211 in the exclusion range storage 33. Further, the discriminator 25 compares a size (a width and a height) of a detected face image with a size of the set minimum detection face Fₘᵢₙ (a minimum face detection width F_{min_w} and a minimum face detection height F_{min_h}, see FIG. 5).

The corrector 26 corrects a frequency of face image detection according to setting of a frequency of face image detection for each region in the imageV. A correction method will be described later.

The image processor 27 processes a face image stored in the object storage 31. After the object detection processing to be described later ends, the image processor 27 arranges, according to coordinates on the image V, a face image stored in the object storage 31 on an image map by which the face authentication device 80 can perform face recognition. Alternatively, the image processor 27 associates coordinate data on the image V with a face image.

The image transmitter 28 transmits the acquired image V, the image map, and the like to the face authentication device 80.

The operator 29 transmits, to the drive device 42, an instruction for moving the imaging range L of the imager 40.

The functional configuration of the controller 20 has been described above. Hereinafter, the object detection processing performed by the image processing device 10 will be specifically described by using an example of a case in which a face image acquired from a captured image is FIG. 2B.

The minimum detection face Fₘᵢₙ (see FIG. 5) smaller than the face image of the person 102 and larger than the face image of the person 103 is preset in the object storage 31. When detection is performed at once on the entire image V, the object detector 22 is unable to detect a face image smaller than the minimum detection face Fₘᵢₙ. The image acquirer 21 causes the imager 40 to capture the imaging range L, and acquires the captured image V. The object detector 22 detects the face images of the persons 101 and 102 from the entire image V transmitted from the image acquirer 21. The object detector 22 stores the detected face images of the persons 101 and 102 in the object storage 31. Note that, the person 103 is not detected at this time since the person 103 is smaller than the minimum detection face Fₘᵢₙ.

The detection frame setter 23 reads the face images of the persons 101 and 102 stored in the object storage 31, and sets a width and a height of the face image of the person 102 being a smallest face image among the read face images, as a width and a height of a frame-overlapping area of the reference detection frame 200 (the diagonally hatched range in FIG. 6). The detection frame setter 23 adds the width and the height of the frame-overlapping area to a width and a height of the reference detection frame 200 to store the results as the detection frame 205 (or the user-set detection frame 206) in the detection frame storage 32.

The object detector 22 divides the image V by the detection frame 205 (or the user-set detection frame 206) into regions with a frame-overlapping area having an overlapping width and an overlapping height as illustrated in FIG. 6, and then detects a face image in each of the divided regions. Within a divided region, the face image of the person 103 is larger than the minimum detection face Fₘᵢₙ. The object detector 22 detects the face image of the person 103, and stores the detected face image of the person 103 in the object storage 31. The object detector 22 performs a detection operation on all of the divided regions, and completes the detection operation over the entire image V.

The detection frame determiner 24 compares a smallest face among faces detected during the detection operation with the minimum detection face Fₘᵢₙ. Since the face image of the person 103 is detected from the divided region, the detection frame determiner 24 compares the face image of the person 103 with the minimum detection face Fₘᵢₙ, determines that the face image of the person 103 is larger than the minimum detection face Fₘᵢₙ, and determines to shrink the detection frame 205. The detection frame setter 23 calculates a width and a height of the face image of the person 103 being the smallest face image. The detection frame setter 23 adds the width and the height of the frame-overlapping area to a width and a height of the reference detection frame 200 to store the results as the detection frame 205 (or the user-set detection frame 206) in the detection frame storage 32.

The object detector 22 divides the image V by the detection frame 205 (or the user-set detection frame 206) into regions with a frame-overlapping area having an overlapping width and an overlapping height, and then detects a face image in each of the divided regions.

Subsequently, the controller 20 ends the detection after repeating division of the image V and detection of a face image until the width and the height of the frame-overlapping area become as small as the width and the height of the minimum detection face Fₘᵢₙ, and generates a face image map for the entire image V as illustrated in FIG. 6.

(Face Authentication Device)

The face authentication device 80 is, for example, a device based on an eigenface using principal component analysis as an algorithm for face recognition. The face authentication device 80 uses image data transmitted from the image processing device 10 to perform face authentication (two-dimensional face authentication).

[Processing Performed by Image Processing Device]

Next, the object detection processing performed by the image processing device 10 will be described by using a flowchart.

(Object Detection Processing)

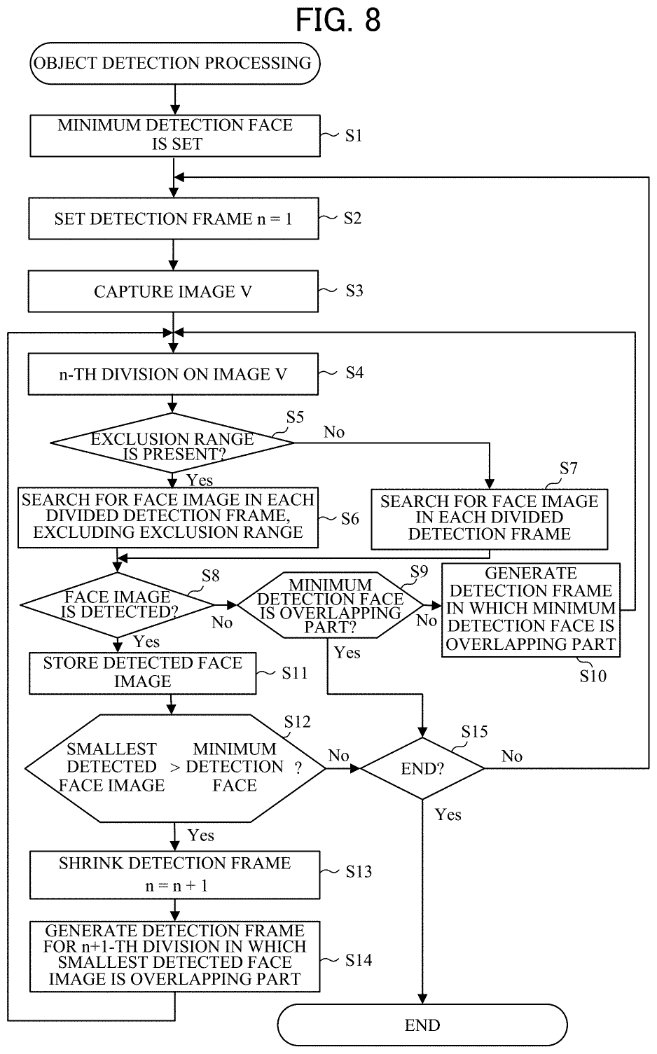

A flow of the object detection processing performed by the image processing device 10 will be described with reference to FIG. 8. The object detection processing can execute detection of a small face in an image while reducing load on the image processing device 10. Consequently, the face authentication device 80 can perform face authentication even on the person 103 whose face image is smaller than the minimum detection face Fₘᵢₙ.

First, the minimum detection face Fₘᵢₙ is set in the image processing device 10 (Step S1). The minimum detection face Fₘᵢₙ can also be voluntarily set by a user through the inputter 70. Further, the imaging range L is also set.

Next, a detection frame 205₁ for use in first (n=1) object detection processing is set. Since face image detection in the first object detection processing is performed at once on the entire image V, the detection frame 205₁ has a same size as the image V. The detection frame setter 23 sets the detection frame 205₁ having a same size as the image V, and stores the detection frame 205₁ in the detection frame storage 32 (Step S2).

The image acquirer 21 causes the imager 40 to capture the imaging range L, acquires the captured image V, and transmits the acquired image V to the object detector 22 (Step S3).

After the image processing device 10 acquires the image V, the detection frame setter 23 reads the detection frame 205₁ from the detection frame storage 32, and divides the image V by the detection frame 205₁. In first division, the entire image V is divided by the detection frame 205₁ having the same size as the image V (Step S4).

The discriminator 25 discriminates presence of the detection frame 205₁or a user-set detection frame 206₁ positioned inside a face image detected in previous division (Step S5). The detection frame 205₁ or the user-set detection frame 206₁ positioned inside a face image detected in previous division is discriminated as the exclusion range 210 or the user-set exclusion range 211, and is stored in the exclusion range storage 33. Note that, since this time is the first division, a face image detected in previous division is absent (Step S5; No), and the processing proceeds to Step S7. The object detector 22 detects a face image from the image V by using the detection frame 205₁ set by the detection frame setter 23 (Step S7). Subsequently, the processing proceeds to Step S8.

In second or subsequent division, when a face image detected in previous division is present and the detection frame 205 positioned inside the face image is present, the detection frame 205 is discriminated as the exclusion range 210 or the user-set exclusion range 211, and is stored in the exclusion range storage 33 (Step S5; Yes). The processing proceeds to Step S6, and the object detector 22 detects a face image from the image V by using the detection frame 205₁ set by the detection frame setter 23, excluding the detection frame 205₁ being the exclusion range 210. Subsequently, the processing proceeds to Step S8.

In Step S8, the object detector 22 determines whether a face image is detected by the detection frame 205₁ in preceding Step S6 or S7.

When no face image is detected (Step S8; No), the detection frame determiner 24 determines whether the minimum detection face Fₘᵢₙ is set as a width and a height of a frame-overlapping area (Step S9). When the minimum detection face Fₘᵢₙ is not set as a width and a height of a frame-overlapping area (Step S9; No), n is incremented by 1 (n=n+1=2), and the detection frame setter 23 adds the minimum detection face Fₘᵢₙ to the reference detection frame 200₂ as a width and a height of a frame-overlapping area to set a detection frame 205₂ smaller than the detection frame 205₁ (Step S10). Subsequently, the processing returns to Step S4, and second division is performed on the image V. When the minimum detection face Fₘᵢₙ is set as a width and a height of a frame-overlapping area (Step S9; Yes), the processing proceeds to Step S15.

When the object detector 22 determines that a face image is detected by the detection frame 205₁ in preceding Step S6 or S7 (Step S8; Yes), the processing proceeds to Step S11.

In Step S11, the object detector 22 stores the detected face image in the object storage 31, and the processing proceeds to Step S12.

The detection frame determiner 24 compares a size of the face image of the person 102 being a smallest face image among the detected face images with a size of the set minimum detection face Fₘᵢₙ (Step S12). When a size of the face image of the person 102 is larger than a size of the set minimum detection face Fₘᵢₙ (Step S12; Yes), the detection frame determiner 24 determines to shrink the detection frame 205. n is incremented by 1 (n=n+1=2) (Step S13), and the processing proceeds to Step S14.

The detection frame setter 23 reads a face image in the image V stored in the object storage 31, and sets a width and a height (see FIG. 5) of the face image of the person 102 being a smallest face image among the read face images, as a width and a height of a frame-overlapping area of the reference detection frame 200. The detection frame setter 23 adds the width and the height of the frame-overlapping area to a width and a height of the preset reference detection frame 200₂ to set the detection frame 205₂ for second (n=2) division in the detection frame storage 32, and stores the detection frame 205₂ in the detection frame storage 32 (Step S14). Subsequently, the processing returns to Step S4, and the detection frame setter 23 performs second (n=2) division on the image V.

When a size of the face image of the person 102 is equal to a size of the set minimum detection face Fₘᵢₙ (Step S12; No), the detection frame determiner 24 determines not to shrink the detection frame 205, and the processing proceeds to Step S15. When the processing ends (Step S15; Yes), the processing ends, and when the processing does not end (Step S15; No), the processing returns to Step S2.

Through the object detection processing described above, the image processing device 10 performs face detection on the entire image V, then divides the image V, and further searches for a face image in each divided detection frame 205. Thus, a face image smaller than the minimum detection face Fₘᵢₙ can be detected from the image V. Further, upon division of the image V after the face detection on the entire image V, the image V is divided by using a width and a height of a smallest face image among detected face images as a frame-overlapping area. Thus, a situation in which a face image captured in the image V is not successfully detected (a situation in which a not-yet-detected face image cannot be detected, because only a part of the face image is captured in each of the adjacent detection frames 205 and 205 and the whole face image does not fit in any of the detection frames 205) can be prevented. Furthermore, the face detection is performed by each detection frame with a resolution of QVGA. Thus, a small face image can be detected while increase in processing load is prevented.

### MODIFICATION EXAMPLE

According to the above-described embodiment, an object being a detection target of the object detector 22 is a face image. However, the object may be a person, a physical object, and the like for person detection and physical object detection (a vehicle and the like).

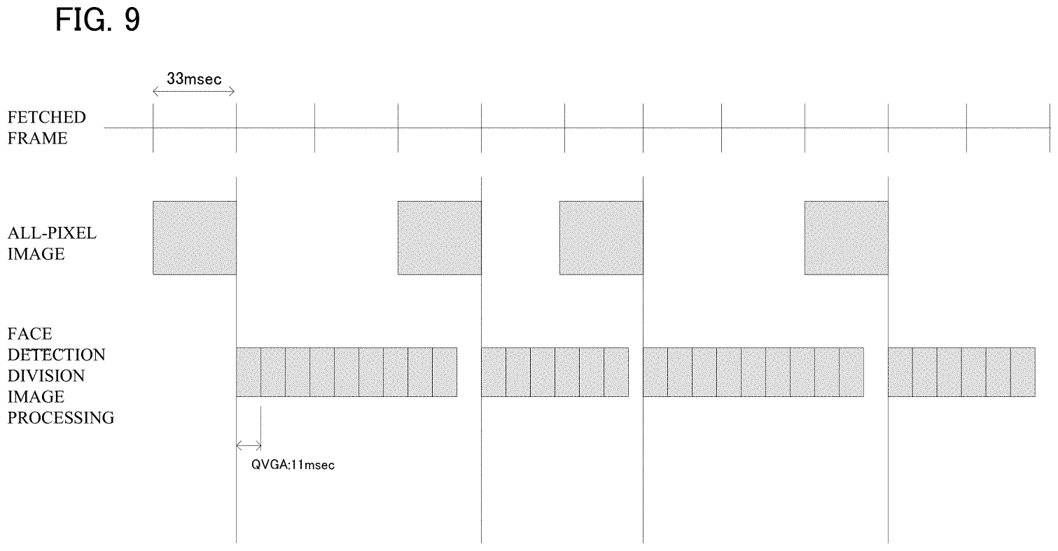

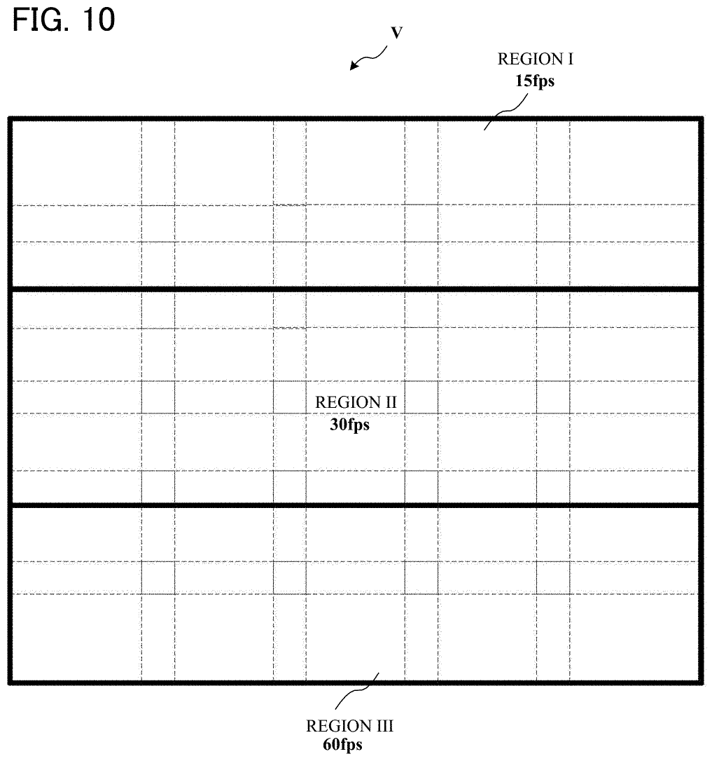

According to the above-described embodiment, the imaging device 41 captures an image at a frame rate of 30 fps, and the image acquirer 21 fetches the image by all pixels in about 33 msec, as illustrated in FIG. 9. The object detector 22 detects a QVGA-face image in each divided region in about 11 msec. Thus, when the image V is fetched once in 100 msec, the number of the detection frames 205 on which a detection operation can be performed is nine, and, when the image V is fetched once in 66 msec, the number of the detection frames 205 on which the detection operation can be performed is six. Thus, besides setting the above-described exclusion range 210 and the like, an approach to reduce the number of detection frames on which the detection operation is performed may be taken. For example, as illustrated in FIG. 10, a frame rate of 15 fps in an upper region I of the image V, a frame rate of 30 fps in an intermediate region II, and a frame rate of 60 fps in a lower region III may be set. Since the imaging device 41 (the imager 40) is mounted on a ceiling, the upper region I of the image V is a range captured far from the imaging device 41 and including a small amount of movement (amount of change) of an object, and thus, keeping a low frame rate causes few problems. On the other hand, the lower region III is a range captured close to the imaging device 41 and including a large amount of movement (amount of change) of an object, and thus, a frame rate is preferably kept high. The corrector 26 stores the thus-corrected detection condition Z in the detection condition storage 34. In a case of VGA or 4K rather than QVGA, more processing time is required, and thus, devising a detection method is useful.

Further, since the region III in FIG. 10 is close to the imaging device 41, a small face image is not detected, and a detection condition for detecting a small face image only in the region I far from the imaging device 41 may be set.

According to the above-described embodiment, the minimum detection face Fₘᵢₙ is set as a width and a height of a frame-overlapping area in Steps S9 and S10 in the object detection processing in FIG. 8. However, a width and a height of a frame-overlapping area may be determined based on a numerical value, an expression, and the like voluntarily set by a user or preset in the detection frame storage 32 and the like.

Further, according to the above-described embodiment, the image processing device 10 includes the imager 40. However, an image processing device may not include an imager and may be connected to an external imaging device that is controllable via the communicator 50.

According to the above-described embodiment, the image processing device 10 generates an image for the face authentication device 80 performing two-dimensional face authentication. However, the image processing device 10 may generate an image for a face authentication device performing three-dimensional face authentication.

Each of the functions of the image processing device 10 according to the present disclosure can be implemented also by a computer such as a normal personal computer (PC). Specifically, according to the above-described embodiment, description has been given assuming that a program for exposure correction processing and image processing performed by the image processing device 10 is stored in advance in the ROM of the storage 30. However, a computer that can achieve each of the above-described functions by storing and distributing a program in a non-transitory computer-readable recording medium such as a flexible disk, a compact disc read-only memory (CD-ROM), a digital versatile disc (DVD), and a magneto-optical (MO) disc and reading and installing the program on the computer may be configured.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An image processing device comprising:
a memory storing a program; and
at least one processor configured to execute a program stored in the memory, wherein
the processor
acquires a captured image,
detects a detection target from the image,
sets a detection frame being a range for detecting the detection target within the image,
determines whether to shrink the detection frame every time a detection operation for the detection target over the entire image is completed,
detects, when the detection frame is newly set, the detection target, based on a newly set detection frame, and
sets, when determining to shrink the detection frame, a detection frame smaller than a detection frame at a time of the detection operation.

2. The image processing device according to claim 1, wherein
the detection frame has a range overlapping with an adjacent detection frame when is shrunk, and
the overlapping range is set based on a size of the detection target.

3. The image processing device according to claim 1, wherein the processor sets a size of the detection frame equal to a size of the image when the detection operation on the image is started.

4. The image processing device according to claim 2, wherein a width and a height of the minimum detectable detection target are equal to a width and a height of the overlapping range when the detection frame becomes smallest.

5. The image processing device according to claim 1, wherein the processor ends setting a detection frame smaller than a detection frame at a time of the detection operation when determining that a size of the detection frame is equal to a size of the minimum detectable detection target.

6. The image processing device according to claim 1, wherein the processor excludes the detection frame positioned inside the detection target from a range for detecting the detection target.

7. The image processing device according to claim 1, wherein a frequency of the detection operation is set higher or lower in a predetermined region of the image than in another region.

8. An image processing method comprising:
acquiring a captured image;
setting a detection frame being a range for detecting a detection target within the image;
determining whether to shrink the detection frame every time a detection operation for the detection target over the entire image is completed;
detecting, when the detection frame is newly set, the detection target, based on a newly set detection frame; and
setting, when determining to shrink the detection frame, a detection frame smaller than a detection frame at a time of the detection operation.

9. The image processing method according to claim 8, wherein
when the detection frame is set to shrink, the detection frame is set as to have a range overlapping with an adjacent detection frame, and
the overlapping range is set based on a size of the detection target.

10. The image processing method according to claim 8, wherein a size of the detection frame is set equal to a size of the image when the detection operation on the image is started.

11. The image processing method according to claim 9, wherein a width and a height of the minimum detectable detection target are set equal to a width and a height of the overlapping range when the detection frame is set to be smallest.

12. The image processing method according to claim 8, wherein setting a detection frame smaller than a detection frame at a time of the detection operation is ended when a size of the detection frame is determined to be equal to a size of the minimum detectable detection target.

13. The image processing method according to claim 8, wherein the detection frame positioned inside the detection target is excluded from a range for detecting the detection target.

14. The image processing method according to claim 8, wherein a frequency of the detection operation is set higher or lower in a predetermined region of the image than in another region.

15. A non-transitory computer-readable recording medium storing a program, the program causing a processor of a computer to function in such a way as to
acquire a captured image,
set a detection frame being a range for detecting a detection target within the image,
determine whether to shrink the detection frame every time a detection operation for the detection target over the entire image is completed,
detect, when the detection frame is newly set, the detection target, based on a newly set detection frame, and
set, when determining to shrink the detection frame, a detection frame smaller than a detection frame at a time of the detection operation.
